(19) United States
(12) Patent Application Publication
(10) Pub. No.: US 2017/0197816 A1
(43) Pub. Date: Jul. 13, 2017

(54) FULLY SEALED WATER DISPENSER MECHANISM

(71) Applicant: VIKING RANGE, LLC, Greenwood, MS (US)

(72) Inventors: Jemsheer Thayyullathil, Greenwood, MS (US); Matthew Ortner, Huntersville, NC (US)

(73) Assignee: Viking Range, LLC

(21) Appl. No.: 15/365,531

(22) Filed: Nov. 30, 2016

Related U.S. Application Data
(60) Provisional application No. 62/276,540, filed on Jan. 8, 2016.

(51) Int. Cl. B67D 1/00; F25D 21/04; F25D 23/12

(52) U.S. Cl. CPC B67D 1/0085; B67D 1/0003; F25D 23/126; F25D 21/04; B67D 2001/0089; B67D 2001/0094

(57) ABSTRACT

A refrigerator water dispenser (10) is disclosed which includes a mounting bracket (11) and a plastic housing (12). The housing houses a water dispensing nozzle (21). The nozzle includes a control valve (22) which is operationally controlled by an electronic switch (23). The housing includes a front panel (27) having a peripheral space (28) which separates the front panel between a peripheral portion (30) and a central portion (31). Hinges (32) allow for the depressed, pivotal movement of the central portion and provides a spring like effect which aids in returning the central portion to its neutral position after it has been manually depressed. A resilient rubber touch pad (34) is coupled to the front side of the housing which includes a peripheral flange (35) that extends into the space of the housing so as to completely seal the entirety of space and therefore the front face of the housing.

### REFERENCE TO RELATED APPLICATION

Applicant claims the benefit of U.S. Provisional Patent Application Ser. No. 62/276,540 filed Jan. 8, 2016.

### TECHNICAL FIELD

This invention relates generally to a water dispenser, and more particularly to a water dispenser which is mounted to a refrigerator.

### BACKGROUND OF INVENTION

Refrigerators have existed for decades. Today's refrigerators oftentimes include a water dispenser and/or ice dispenser mounted to the front side of a refrigerator door. These dispensers provide easy access to water and ice without having to open the refrigerator door.

However, more recently, refrigerators have been designed to include internally mounted water dispensers to provide a clean or unobstructed appearance to the exterior of the refrigerator door. A problem with this internal design has been the encroachment of moisture into the dispenser with the opening and closing of the door and the resulting temperature changes which causes moisture in the air to condense on the cool interior components of the water dispenser. This moisture can create problems with bacteria, mold and the degrading of electrical components.

Accordingly, it is seen that a need remains for a water dispenser that can be placed in a cool environment of a refrigerator without being susceptible to moisture. It is to the provision of such therefore that the present invention is primarily directed.

### SUMMARY OF THE INVENTION

A refrigerator water dispenser comprises a housing having a front panel with a central portion substantially surrounded by a peripheral portion separate and apart from the central portion. The central portion is separated from the peripheral portion by a peripheral space substantially encompassing the central portion. The dispenser has at least one hinge pivotally coupling the central portion to the peripheral portion for movement of the central portion between a neutral position and an engaged position, an electronic switch mounted to contact the cental portion when the central portion is in its engaged position, a water nozzle having a control valve controlled by the actuation of the electronic switch, and a resilient cover substantially covering the central portion and having at least a portion of the resilient cover being position within the peripheral space to bias the central portion from its engaged position towards its neutral position.

### BRIEF DESCRIPTION OF DRAWINGS

FIG. 1 is a perspective front view of a refrigerator water dispenser embodying principles of the invention in a preferred form.

FIG. 2 is perspective, front view of the mounting bracket, nozzle and electronic switch of the refrigerator water dispenser of FIG. 1.

FIG. 3 is a perspective front view of the housing and touch pad of the refrigerator water dispenser of FIG. 1.

FIG. 4 is a perspective rear view of the housing of the refrigerator water dispenser of FIG. 1.

FIG. 5 is perspective rear view of the housing and touch pad of the housing and touch pad of the refrigerator water dispenser of FIG. 1.

FIG. 6 is a perspective, front view of the refrigerator water dispenser of FIG. 1 shown with some portions in phantom lines.

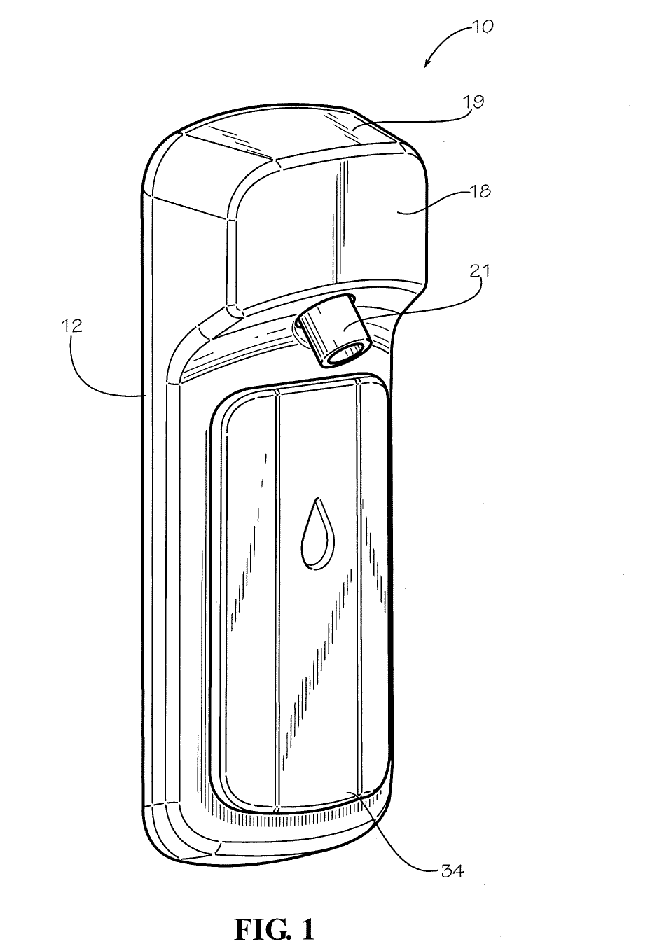

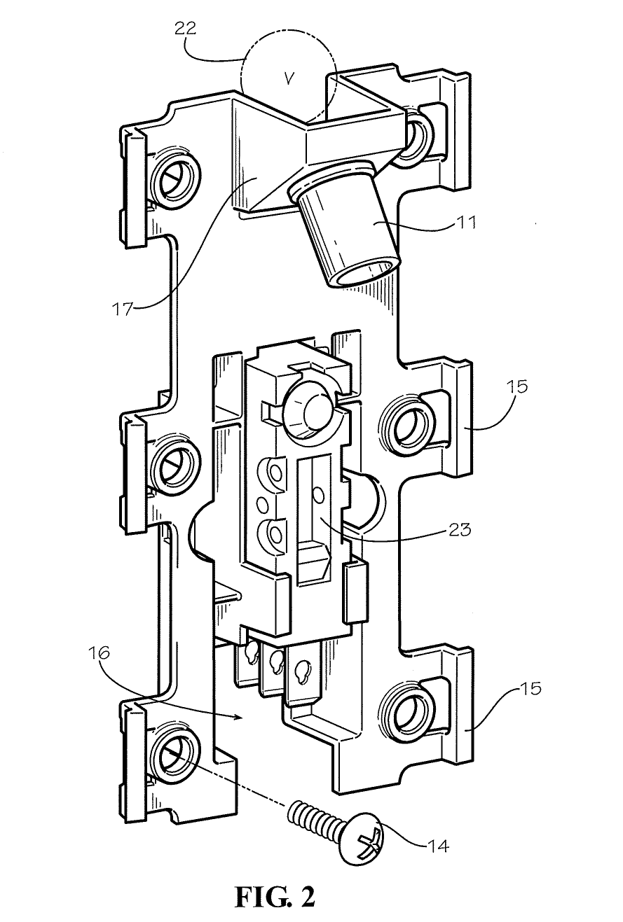

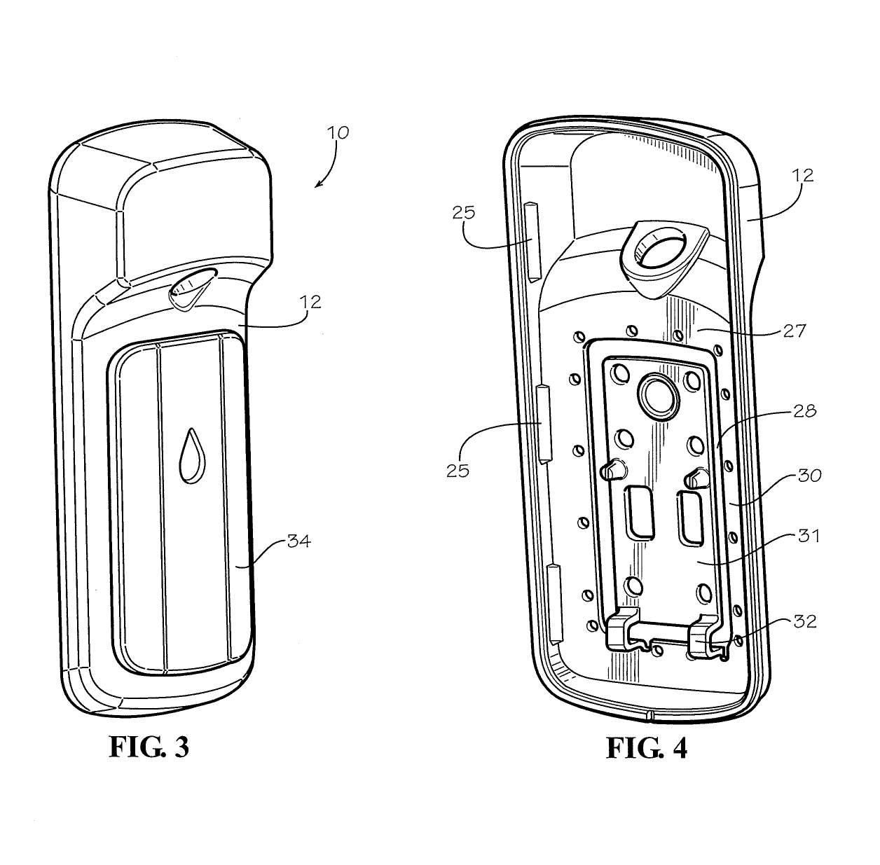

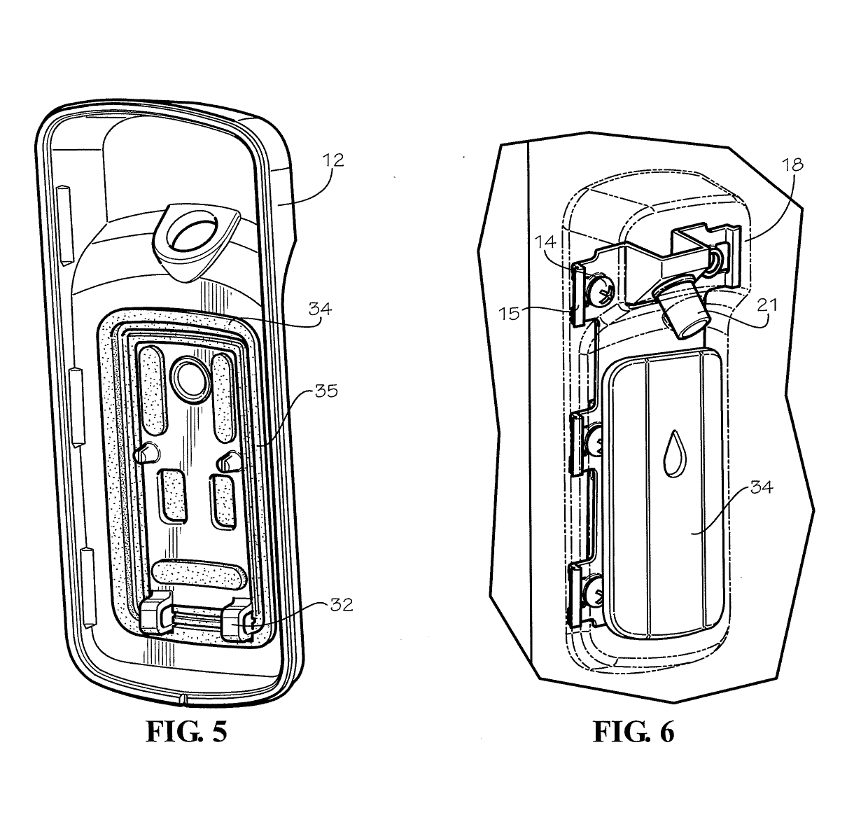

### DETAILED DESCRIPTION

With reference next to the drawings, there is shown a water dispenser 10 according to a preferred form of the present invention. The water dispenser 10 is preferably mounted to the interior space of a refrigerator.

The water dispenser 10 includes a metal mounting bracket 11 and a plastic mount or housing 12 coupled to the mounting bracket 11. The mounting bracket 11 is mounted to the interior of the refrigerator through mounting screws 14. The mounting bracket 11 includes a peripheral series of snap-type mounting flanges 15 and a central opening 16. The top end of the mounting bracket includes a nozzle mount 17.

The housing 12 is generally rectangular in shape with an enlarged portion 18 at a top end 19. The enlarged portion 18 houses the mounting bracket nozzle mount 17 and a water dispensing nozzle 21 which is coupled to the nozzle mount 17 and in fluid communication with a waterline within the refrigerator. The nozzle 21 includes a control valve 22 which is operationally controlled by an electronic switch 23. The housing 12 has internal beveled flanges 25 which are sized and shaped to releaseably mate with the mounting flanges 15 of the metal mounting bracket 11 in a snap-fit style.

The housing 12 includes a front panel 27 having a generally rectangular peripheral cut or space 28 which substantially surrounds or encompasses and thereby separates the front panel 27 between a housing stationary, peripheral portion 30 and a housing, movable, central portion 31. The space 28 extends generally about the entire central portion 31. Two C-shaped spring hinges 32 integrally extend between the central portion 31 and peripheral portion 30. The central portion 31 accordingly is integral with the peripheral portion 30 as they are formed of one continuous piece of molded plastic and connected to each other through the hinges 32. The hinges 32 allow for the depressed, pivotal movement of the central portion 31 relative to the peripheral portion 30 as well as providing a spring like effect which aids in returning the central portion 31 to its neutral position after it has been manually depressed to an engaged position and thereafter released. The electronic switch 23 is mounted within the central opening 16 of the mounting bracket 11 closely adjacent the backside of the central portion 31. With this positioning, the central portion 31 engages and thereby activates the electronic switch 23 when the central portion 31 is manually depressed or pivoted inwardly from its neutral position to its engaged position.

A resilient rubber touch pad 34 is coupled to the front side of the housing 12 about the central portion 31. The touch pad 34 has a peripheral flange 35 that extends into the space 28 of the housing 12 so as to completely seal the entirety of space 28 and therefore the front face of the housing 12. The placement of the elastic, rubber touch pad material within the space also creates a spring or spring like effect which returns or aids in returning the central portion 31 of the housing front panel 27 to its neutral or forward position after it has been manually depressed to its engaged position and thereafter released.

In use, the manual depression virtually anywhere upon the touch pad 34 causes the central portion 31 to move inwardly and pivot about hinges 32 and into engagement with electronic switch 23. The activation of the electronic switch 23 causes control valve 22 to open and thereby release the flow of water through nozzle 21. Thus, the water dispenser is actuated by a drinking glass, or any object, hitting the touch pad at any location of the touch pad 34 or the front panel, a departure from the prior art dispensers which typically include a select actuation portion which is a small portion of the dispenser's front facing surface. The central portion 31 is returned to its initial position through the biasing force of the hinges 32 and/or the decompression of the resilient material which comprises the touch pad 34.

As the touch pad seals the opening or space 28 it should be understood that the housing 12, in conjunction with the refrigerator, is sealed so that ambient moisture does not enter the interior of the water dispenser 10. Furthermore, liquids are also prevented from splashing against the drinking glass or ice therein and entering the water dispenser.

It should be understood that the touch pad may be made of any liquid impermeable, resilient material which provides a spring like biasing force upon compression and subsequent decompression of the pad material.

It thus is seen that a water dispenser is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention.

1. A refrigerator water dispenser comprising:
a housing having a front panel with a central portion substantially surrounded by a peripheral portion separate and apart from said central portion, said central portion being separated from said peripheral portion by a peripheral space substantially encompassing said central portion;
at least one hinge pivotally coupling said central portion to said peripheral portion for movement of said central portion between a neutral position and an engaged position;
an electronic switch mounted to contact said cental portion when said central portion is in its engaged position;
a water nozzle having a control valve controlled by the actuation of said electronic switch, and
a resilient cover substantially covering said central portion and having at least a portion of said resilient cover being position within said peripheral space to bias said central portion from its engaged position towards its neutral position.

2. The refrigerator water dispenser of claim 1 wherein said resilient cover includes a mounting flange completely sealing the entirety of said peripheral space.

3. The refrigerator water dispenser of claim 1 wherein said peripheral space completely surrounds said central portion.

4. The refrigerator water dispenser of claim 3 wherein said resilient cover includes a mounting flange completely sealing the entirety of said peripheral space.

5. The refrigerator water dispenser of claim 1 further comprising a mounting plate and wherein said housing is coupled to said mounting plate.

6. The refrigerator water dispenser of claim 5 wherein said mounting plate includes a plurality of mounting flanges and wherein said housing includes a plurality of mounting flanges releasably engaging said mounting flanges of said mounting plate.

7. A refrigerator water dispenser comprising:
a housing having a movable, central portion and a stationary, peripheral portion extending about said central portion;
a resilient cover substantially covering said central portion, said resilient cover extending about the periphery of said central portion, said resilient cover coupling said central portion to said peripheral portion for spring biased movement of said central portion from a depressed position towards a neutral position;
an electronic switch positioned to contact said cental portion upon movement of said central portion to its engaged position, and
a water nozzle having a control valve controlled by the actuation of said electronic switch.

8. The refrigerator water dispenser of claim 7 further comprising at least one hinge pivotally coupling said central portion to said peripheral portion for movement of said central portion between the neutral position and the engaged position.

9. The refrigerator water dispenser of claim 7 wherein said resilient cover includes a mounting flange extending completely around said central portion.

10. The refrigerator water dispenser of claim 9 wherein a peripheral space completely surrounds said central portion and wherein said mounting flange is positioned within said peripheral space.

11. The refrigerator water dispenser of claim 7 further comprising a mounting plate and wherein said housing is coupled to said mounting plate.

12. The refrigerator water dispenser of claim 11 wherein said mounting plate includes a plurality of mounting flanges and wherein said housing includes a plurality of mounting flanges releasably engaging said mounting flanges of said mounting plate.

13. A refrigerator water dispenser comprising:
a housing having a movable, central portion and a peripheral portion extending about at least a portion of said central portion, said central portion being coupled to said peripheral portion by at least one hinge;
a resilient cover covering at least a portion of said central portion, at least a portion of said resilient cover extending between said central portion and said peripheral portion to provide a spring biasing force upon said central portion a depressed position towards a neutral position;
a switch positioned to contact said cental portion while in its engaged position, and
a water nozzle having a control valve controlled by the actuation of said switch.

14. The refrigerator water dispenser of claim 13 wherein said resilient cover includes a mounting flange extending completely around said central portion.

15. The refrigerator water dispenser of claim 13 further comprising a mounting plate and wherein said housing is coupled to said mounting plate.

16. The refrigerator water dispenser of claim 15 wherein said mounting plate includes a plurality of mounting flanges and wherein said housing includes a plurality of mounting flanges releasably engaging said mounting flanges of said mounting plate.
